(19) United States
(12) Patent Application Publication
(10) Pub. No.: US 2010/0078499 A1
(43) Pub. Date: Apr. 1, 2010

(54) NOZZLE FOR FLUID DELIVERY SYSTEM

(75) Inventors: Christopher J. Sulzer, St. Louis Park, MN (US); James J. Handzel, Golden Valley, MN (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: WAGNER SPRAY TECH CORPORATION, Plymouth, MN (US)

(21) Appl. No.: 12/569,516

(22) Filed: Sep. 29, 2009

Related U.S. Application Data
(60) Provisional application No. 61/101,741, filed on Oct. 1, 2008.

(51) Int. Cl. B05B 7/28; B05B 7/04; B05B 1/02

(52) U.S. Cl. 239/8; 239/311; 239/590

(57) ABSTRACT

The present disclosure generally relates to a nozzle or tip for a fluid delivery system, and more specifically, but not by limitation, to a nozzle for a texture sprayer. In one exemplary embodiment, a texture spraying system is provided and includes a spraying device, an air source configured to provide pressurized air to the spraying device, and a texture material source configured to provide texture material to the spraying device. The system also includes a nozzle mounted proximate an output of the spraying device. The nozzle receives a flow of air and a flow of texture material. The nozzle includes a pin positioned in the airflow and is configured to produce a spray pattern that is substantially rectangular.

### CROSS-REFERENCE TO RELATED APPLICATION

The present application is based on and claims the benefit of U.S. provisional patent application Ser. No. 61/101,741 filed Oct. 1, 2008, the content of which is hereby incorporated by reference in its entirety.

### BACKGROUND

The present disclosure generally relates to a nozzle or tip for a fluid delivery system, and more specifically, but not by limitation, to a nozzle for a texture sprayer.

One example of a fluid delivery system comprises a spray-coating system having a device configured to spray a fluid material (e.g., paint, ink, varnish, texture, etc.) through the air onto a surface. Such spray-coating systems often include a fluid material source and, depending on the particular configuration or type of system, a motor for providing pressurized fluid material and/or air to an output nozzle or tip that directs the fluid material in a desired spray pattern. For example, some common types of fluid delivery systems employ compressed gas, usually air compressed by an air compressor, to atomize and direct fluid material particles onto a surface. Other common types of fluid delivery systems include airless systems that employ a pumping unit for pumping fluid material from a source, such as a container. Pressurized fluid material is pumped from the source through a hose, for example, to a spray gun having a tip or nozzle for directing the fluid material.

The discussion above is merely provided for general background information and is not intended to be used as an aid in determining the scope of the claimed subject matter.

### SUMMARY

The present disclosure generally relates to a nozzle or tip for a fluid delivery system, and more specifically, but not by limitation, to a nozzle for a texture sprayer. In one exemplary embodiment, a texture spraying system is provided and includes a spraying device, an air source configured to provide pressurized air to the spraying device, and a texture material source configured to provide texture material to the spraying device. The system also includes a nozzle mounted proximate an output of the spraying device. The nozzle receives a flow of air and a flow of texture material. The nozzle includes a pin positioned in the air flow and is configured to produce a spray pattern that is substantially rectangular.

These and various other features and advantages will be apparent from a reading of the following Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a schematic diagram illustrating an exemplary fluid delivery system.

FIG. 2 is a cross-sectional view of a portion of an exemplary spray gun having a nozzle, under one embodiment.

FIGS. 3-5 are perspective views of the nozzle illustrated in FIG. 2.

FIG. 6 is an end view of the nozzle illustrated in FIG. 2.

FIG. 7 is a cross-sectional view of the nozzle illustrated in FIG. 6 taken at line 7-7.

FIG. 8 is a cross-sectional view of the nozzle illustrated in FIG. 6 taken at line 8-8.

FIG. 9 is a cross-sectional view of one embodiment of a nozzle illustrating an exemplary fluid flow.

FIG. 10 is a cross-sectional view of an exemplary spray gun having a nozzle, under one embodiment.

FIGS. 11-12 are perspective views of the nozzle illustrated in FIG. 10.

### DETAILED DESCRIPTION

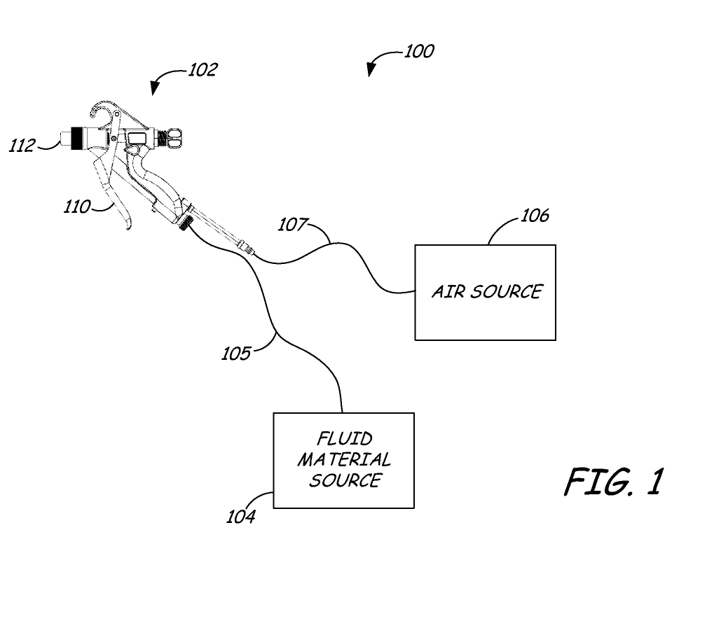

FIG. 1 is a schematic diagram illustrating an exemplary fluid delivery system 100. System 100 includes an exemplary spray gun 102 configured to spray fluid material from an output 112 when a trigger 110 is actuated. Output 112 comprises a nozzle or tip configured to discharge the fluid material in a desired spray pattern. In one embodiment, the fluid material is entrained in an airflow from spray gun 102. In one particular example, spray gun 102 is configured to atomize the fluid material that is sprayed through the air. Examples of fluid materials include, but are not limited to, primers, inks, paints, varnishes, block fillers, elastomerics, drywall mud, textures, popcorn, and splatter finishes, herbicides, insecticides, and food products, to name a few.

In one embodiment, fluid delivery system 100 comprises an airless system that employs a fluid source and, depending on the particular configuration or type of system, an electric motor or drive for providing pressurized fluid to output 112. In the embodiment illustrated in FIG. 1, fluid delivery system 100 comprises a system that employs air (e.g., air provided from a turbine, air compressed by an air compressor, etc.) to propel material from output 112.

A fluid material source 104 is configured to provide fluid material to spray gun 102. Material source 104 can be mounted to spray gun 102 (e.g., an onboard hopper or container) and/or can be remote from (e.g., not mounted to) spray gun 102. In the embodiment illustrated in FIG. 1, fluid material source 104 pumps fluid material to spray gun 102 through a tube 105. An air source 106 is configured to provide air to spray gun 102 that is used to propel the fluid material provided from fluid material source 104. Air source 106 can be mounted to spray gun 102 (e.g., an onboard turbine or compressor) and/or can be remote from (e.g., not mounted to) spray gun 102. In the embodiment illustrated in FIG. 1, air source 106 comprises an air compressor that provides compressed air to spray gun 102 through a tube 107.

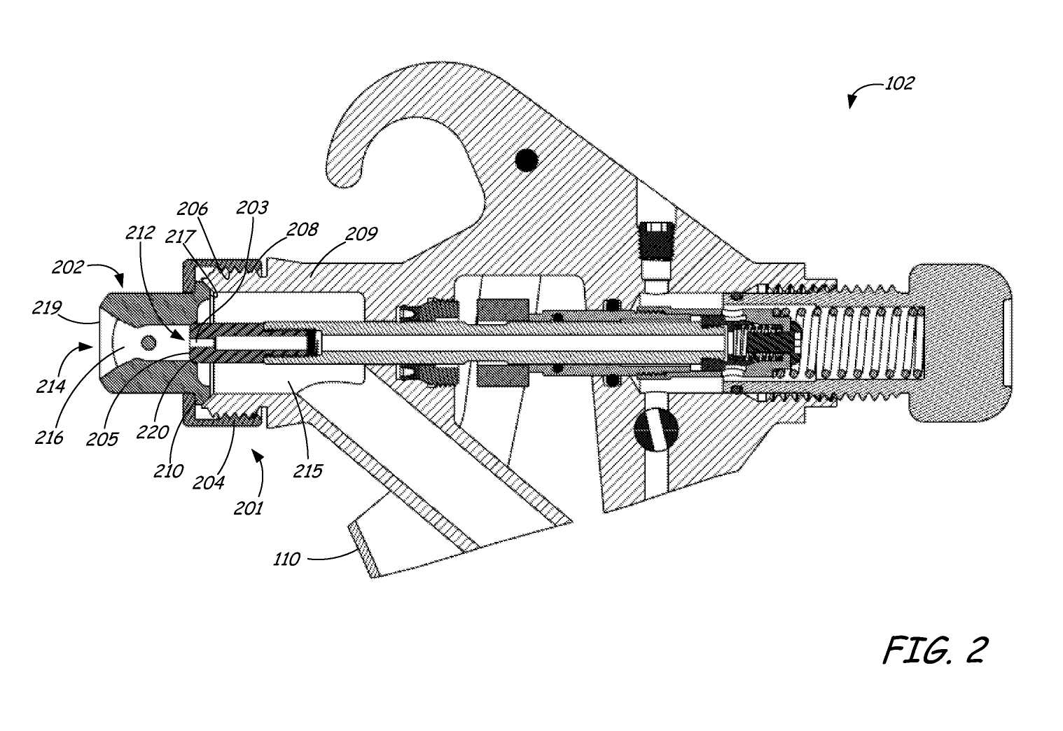

FIG. 2 is a cross-sectional view of one embodiment of spray gun 102. Fluid material is supplied from a fluid source, such as source 104 illustrated in FIG. 1, to a chamber 215 of spray gun 102. As illustrated in FIG. 2, an air nozzle 205 is engaged to an air nozzle seat, thereby forming a seal that limits or prevents the fluid material from flowing out of the chamber 215.

When a user first actuates the trigger 110 of spray gun 102, air (provided from an air source, such as source 106 illustrated in FIG. 1) is provided to an output 203 of the air nozzle 205. In one embodiment, when the trigger 110 is actuated further (i.e., pulled past a particular position), the air nozzle 205 retracts from and disengages the air nozzle seat. As the air nozzle 205 retracts, fluid material is delivered from chamber 215, which mixes with the air delivered by air nozzle 205.

In one embodiment, spray gun 102 is utilized in a portable texture spraying system. In one exemplary system, the air source provides an airflow having a pressure of approximately 10 to 45 pounds per square inch (PSI) inside air nozzle 205 just upstream of orifice 208. Further, in one example the fluid source provides a flow of texture material having a flow rate of approximately 0.75 to 1.25 gallons per minute (GPM). Examples of texture material include, but are not limited to, fine, medium, and coarse textures. The texture material can include particles that are made of polymers, such as expanded polystyrene and the like. In one embodiment, some or all of the texture material particles can have thicknesses that are greater than 0.1 inches. In one embodiment, some or all of the texture material particles can have thicknesses of approximately 0.1 inches to 0.18 inches. It is noted that these are examples of texture materials. The texture material can include particles that are smaller than 0.1 inches and/or larger than 0.18 inches.

Particular examples of the texture material include, but are not limited to, USG Sheetrock® brand Ceiling Spray Texture (Coarse, Medium, and Fine) Popcorn Finish and USG Sheetrock® brand Lightweight All Purpose Joint Compound.

A spray nozzle 202 is mounted at an end 201 of spray gun 102 and is configured to produce a desired spray pattern. Spray nozzle 202 is positioned proximate the air nozzle 205 and is removably coupled to the body 209 of spray gun 102 using a collar 204. Collar 204 includes threads 206 that engage corresponding threads 208 on body 209. Nozzle 202 includes a shoulder portion 210 that extends toward body 209. Shoulder portion 210 has a surface that faces and contacts the body 209 of spray gun 102 and a surface that contacts the collar 204 for securing the nozzle 202 to body 209.

Nozzle 202 can be made out of any suitable material(s) including, but not limited to, metals, fabrics, natural and synthetic polymers (such as plastics and rubbers), and/or combinations thereof. In one particular embodiment, nozzle 202 is made of polypropylene.

Nozzle 202 has a first end 217 including an aperture or opening 212 that is configured to receive the air and fluid material provided from air nozzle 205 and chamber 215, respectively. In one embodiment, the first opening 212 is at least partially formed by a portion of nozzle 202 comprising a seat 220 for air nozzle 205. Nozzle 202 also includes a second end 219 including a second aperture or opening 214 forming an output for spraying the fluid material/air mixture. A cavity 216 extends between openings 212 and 214.

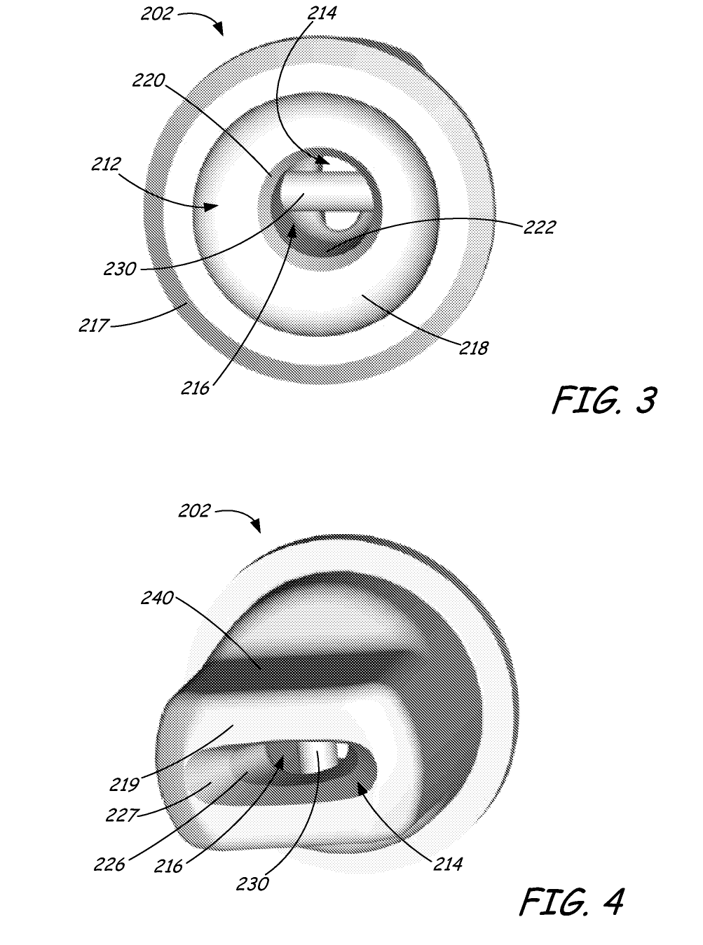

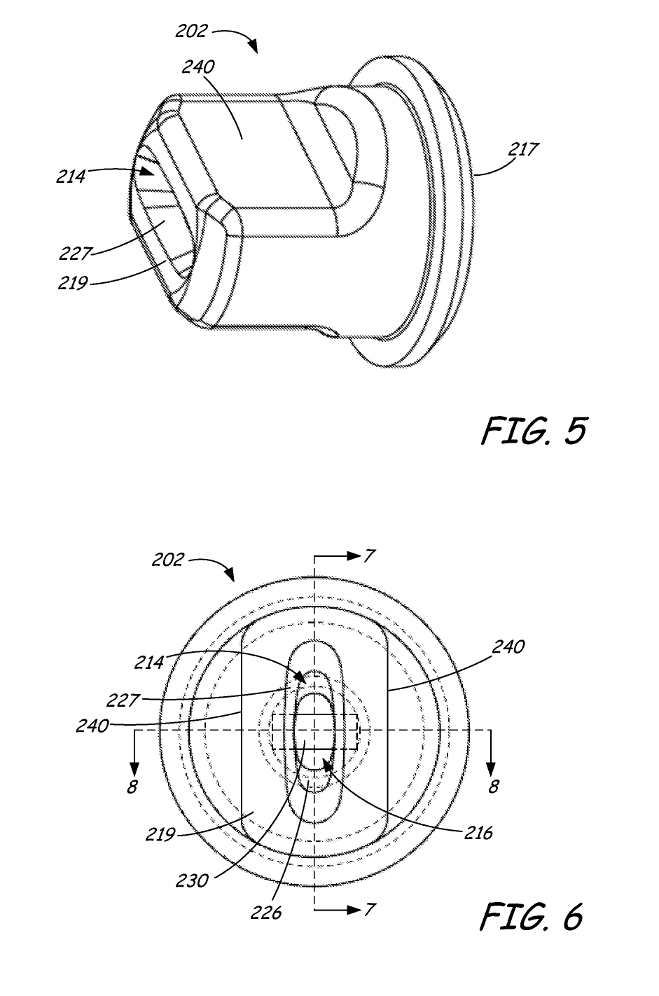

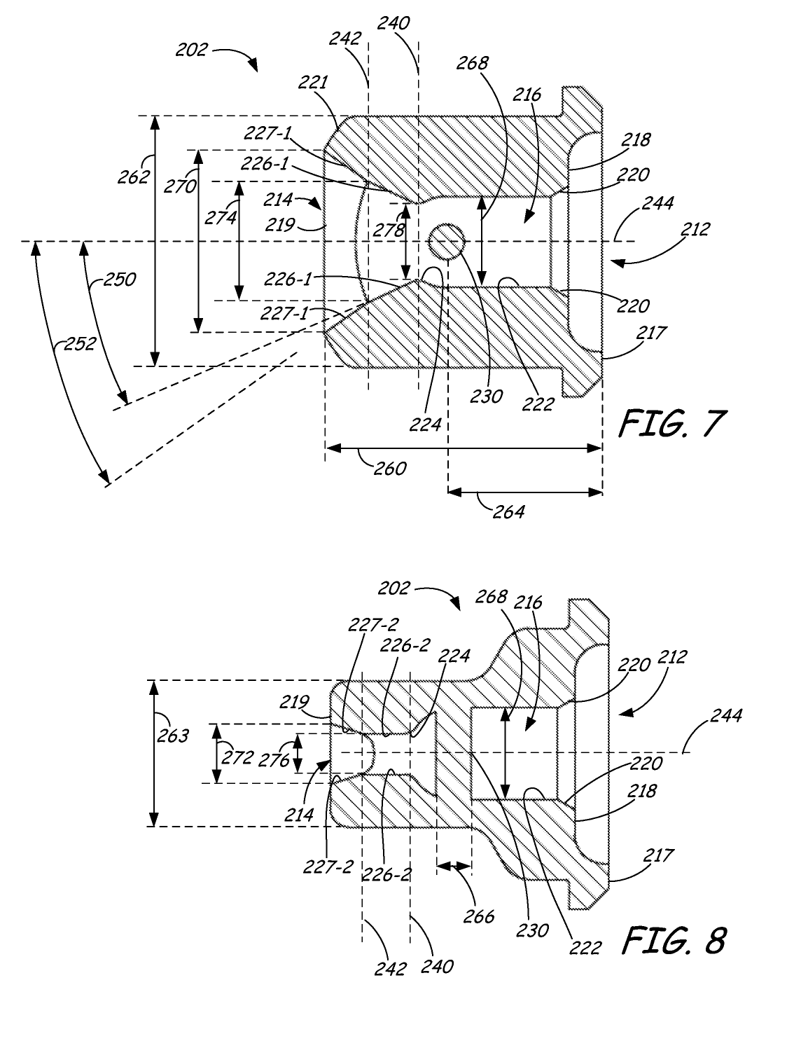

FIGS. 3-8 comprise views of nozzle 202. FIGS. 3-5 are perspective views of nozzle 202. FIG. 6 is an end view of nozzle 202. FIGS. 7 and 8 are cross-sectional views of nozzle 202 taken at lines 7-7 and 8-8, respectfully, illustrated in FIG. 6. FIG. 8 illustrates nozzle 202 rotated 90 degrees with respect to the orientation of nozzle 202 illustrated in FIG. 7.

FIG. 3 is a perspective view of nozzle 202 taken from end 217. As illustrated, cavity 216 formed between openings 212 and 214 is defined by a plurality of interior surfaces of nozzle 202. The plurality of interior surfaces includes a surface 218 that is substantially arcuate and is formed proximate end 217. Air nozzle seat 220 (also illustrated in FIGS. 7 and 8) comprises an angled surface of cavity 216 that is configured to mate to a surface of the air nozzle 205 (shown in FIG. 2) of spray gun 102, thereby forming a fluid seal. Another surface 222 (also illustrated in FIGS. 7 and 8) comprises a cylindrical sidewall.

As illustrated in FIGS. 4-6, nozzle 202 also includes one or more exterior surfaces 240 that are configured to enable a user to easily grasp and rotate nozzle 202 with respect to spray gun 102. Rotation of nozzle 202 allows the user to adjust (e.g., rotate) the spray pattern. In the illustrated embodiment, the exterior surfaces 240 comprise two (or more) surfaces that are flat (or substantially flat) on opposite sides of the nozzle 202. However, any suitable configuration of surfaces 240 can be utilized.

As illustrated in FIG. 6 (which is an end view of nozzle 202 taken at end 219), the opening 214 of nozzle 202 has a shape similar to an ellipse, oval, or stretched circle. A portion of cavity 216 proximate the opening 214 is formed by surfaces 226 and 227. Further, end 219 can include angled or rounded edges 221 (shown in FIG. 7).

As illustrated in FIGS. 7 and 8, surface 226 extends between a first plane (represented by reference numeral 240) and a second plane (represented by reference numeral 242). Surface 227 extends between the second plane (represented by reference numeral 242) and the end 219 of nozzle 202.

Surface 226 includes top and bottom portions (illustrated in FIG. 7 and represented by reference numeral 226-1) and side portions (illustrated in FIG. 8 and represented by reference numeral 226-2). In the illustrated embodiment, top and bottom portions 226-1 are oriented at an angle 250 with respect to a center axis 244 of cavity 216. In one example, angle 250 is approximately 25 degrees. Side portions 226-2 are substantially parallel to center axis 244.

Surface 227 includes top and bottom portions (illustrated in FIG. 7 and represented by reference numeral 227-1) and side portions (illustrated in FIG. 8 and represented by reference numeral 227-2). In the illustrated embodiment, top and bottom portions 227-1 are oriented at an angle 252 with respect to the center axis 244 of cavity 216. As illustrated, angle 252 is different than angle 250. In one example, angle 252 is approximately 35 degrees. Side portions 227-2 are also angled with respect to center axis 244.

Nozzle 202 includes a length 260 from end 217 to end 219 and widths 262 and 263. In one embodiment, length 260 is approximately 0.94 inches, width 262 is approximately 0.86 inches, and width 263 is approximately 0.5 inches. Further, in one embodiment the cylindrical sidewall 222 comprises a diameter 268 of approximately 0.31 inches.

In one embodiment, cavity 216 has a height 270 and width 272 at end 219 of approximately 0.61 inches and 0.2 inches, respectively. At plane 242, cavity 216 has a height 274 and width 276 of approximately 0.42 inches and 0.14 inches, respectively.

Further, as illustrated in FIGS. 7 and 8 cavity 216 is formed by a narrowed portion comprising a protrusion or lip 224. The portion of cavity 216 formed by lip 224 has a smaller cross-section than the portion of cavity 216 formed by cylindrical sidewall 222. In one embodiment, at lip 224 cavity 216 has a cross-sectional height 278 that is approximately 80-85 percent of the diameter 268 of cylindrical sidewall 222. In one embodiment, the cross-sectional height 278 and width of the cavity 216 at lip 224 is approximately 0.264 inches and 0.14 inches, respectively.

In accordance with one embodiment, nozzle 202 includes a pin 230 positioned within cavity 216. Pin 230 is configured to divert or deflect fluid flowing in cavity 216. In the illustrated example, pin 230 is substantially cylindrical. However, other configurations (including other sizes and shapes) for pin 230 can be utilized.

In one embodiment, pin 230 has a diameter 266 that is approximately 35-45 percent of the diameter 268. In one embodiment, pin 230 has a diameter 266 of approximately 0.122 inches and is positioned a distance 264 of approximately 0.53 inches from end 217.

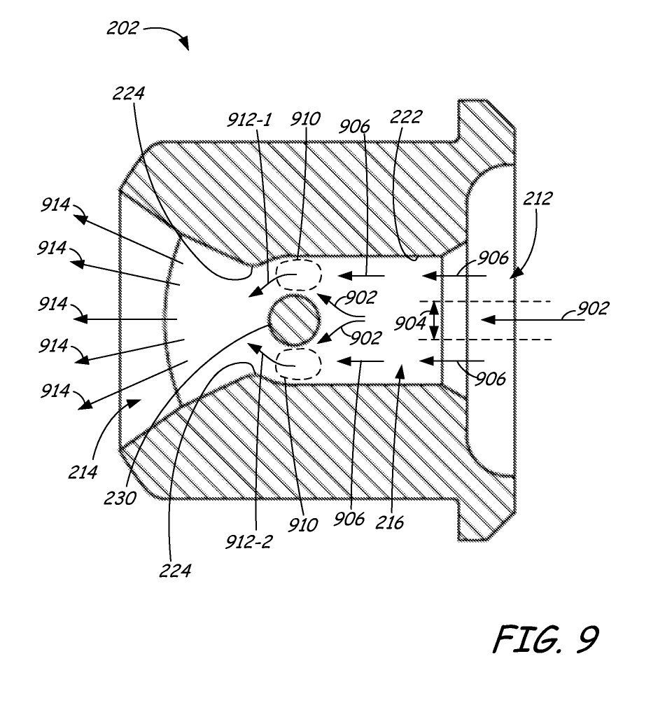

In the illustrated embodiment, pin 230 is centered along center axis 244 of cavity 216 and is configured to deflect air (for example, air from air nozzle 205) entering cavity 216. This is advantageous in applications (such as the spray gun illustrated in FIG. 2), where the pressurized air entering the nozzle 202 is concentrated along a center of axis (i.e., axis 244). Pin 230 deflects the air and can enable increased mixing (e.g., atomization, etc.) of the fluid material (e.g., texture material provided from chamber 215). To illustrate, FIG. 9 is a cross-sectional view of nozzle 202 showing an exemplary fluid flow therethrough.

While nozzle 202 illustrated in FIG. 9 is described in the context of the spray gun 102 shown in FIG. 2, it is noted that nozzle 202 can be implemented in other types of spraying applications. As shown in FIG. 9, an air stream 902 provided from air nozzle 205 enters the opening 212 into cavity 216. In one embodiment, the air stream 902 provided from air nozzle 205 enters the cavity 216 within a first diameter 904. A fluid material stream 906 (e.g., texture, paint, etc.) is provided from the chamber 215 of spray gun 102. In one embodiment, some or all of the fluid material stream 906 enters the cavity 216 at a second diameter that is larger than the first diameter 904. In other words, in one embodiment some or all of the fluid material stream 906 enters the cavity 216 between the cylindrical sidewall 222 and the first diameter 902 within which the air stream 902 is provided.

The air stream 902 travels through the cavity 216 and is deflected by pin 230. In one embodiment, a first portion of the air stream 902 is deflected to a first side of pin 230 and a second portion of the air stream 902 is deflected to a second side of pin 230. In one example, the first and second portions are substantially equal.

The first and second portions of the air stream 902 mix with corresponding portions of the fluid material stream 906, thereby entraining the fluid material in the airflow. In the illustrated example, the air stream 902 and fluid material stream 906 mix at areas of the cavity 216 generally represented by dashed lines 910.

The air/fluid material mixtures (generally represented by arrows 912-1 and 912-2) are deflected by the narrowed portion (i.e., lip 224) of nozzle 202. In the embodiment illustrated in FIG. 9, some or all of the narrowed portion (i.e., lip 224) is positioned “downstream” from pin 230. Deflection of mixtures 912-1 and 912-2 causes at least a portion of each of the mixtures 912-1 and 912-2 to meet and/or cross paths within cavity 216. The air/fluid material mixtures exit the opening 214 in a flat or fan spray pattern (generally represented by arrows 914). In one embodiment, a flat or fan spray pattern comprises a substantially rectangular spray pattern.

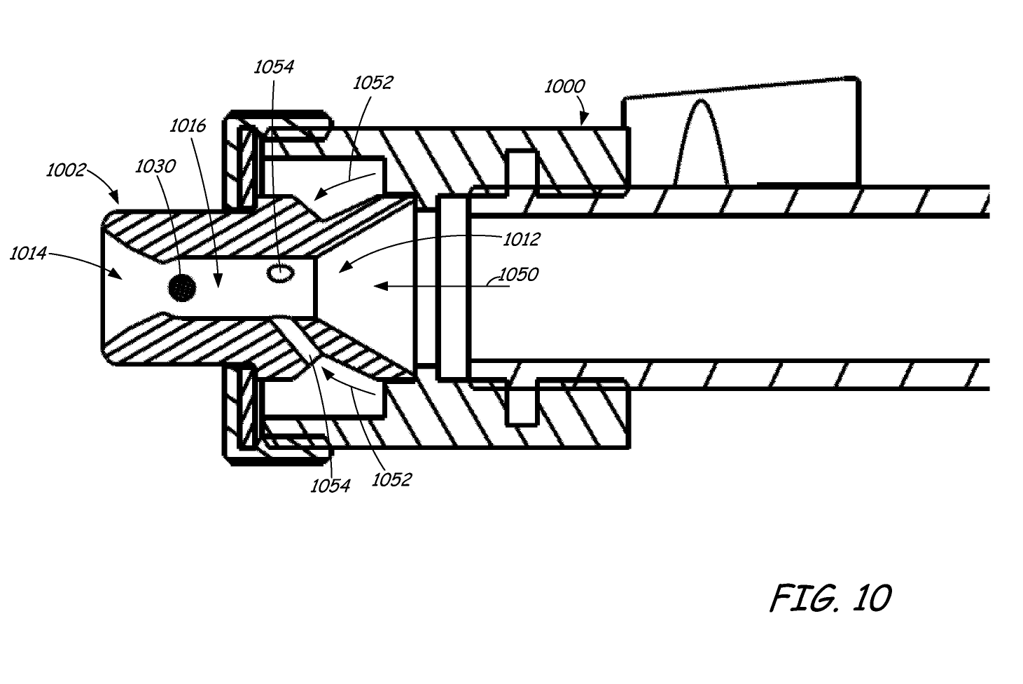

It is noted that while nozzle 202 is described in the context of spray gun 102 illustrated in FIG. 2, concepts described herein can be applied in other applications. For example, FIG. 10 illustrates one embodiment of a spray gun 1000 and a nozzle 1002. Spray gun 1000 is configured to provide a fluid material flow 1050 into an opening 1012 of nozzle 1002. The fluid material flow 1050 travels through opening 1012 into cavity 1016. Spray gun 1000 is also configured to provide an air flow 1052. Air flow 1052 enters cavity 1016 through one or more apertures 1054 formed in a side portion of nozzle 1002. In this manner, apertures 1054 are physically separated from opening 1012 through which the fluid material flow 1050 enters cavity 1016. The fluid material flow 1050 and the air flow 1052 mix within cavity 1016, which includes a pin 1030. In one embodiment, pin 1030 is substantially similar to pin 230.

Further, it is noted that in one embodiment cavity 1016 includes one or more surfaces that are similar to surfaces described above with respect to nozzle 202. For example, nozzle 1002 can include surfaces that are the same as, or substantially similar to, lip 224, angled surfaces 226 and 227, and/or cylindrical sidewall 222, for example. A mixture of the air and fluid material flows exit nozzle 1002 through output opening 1014.

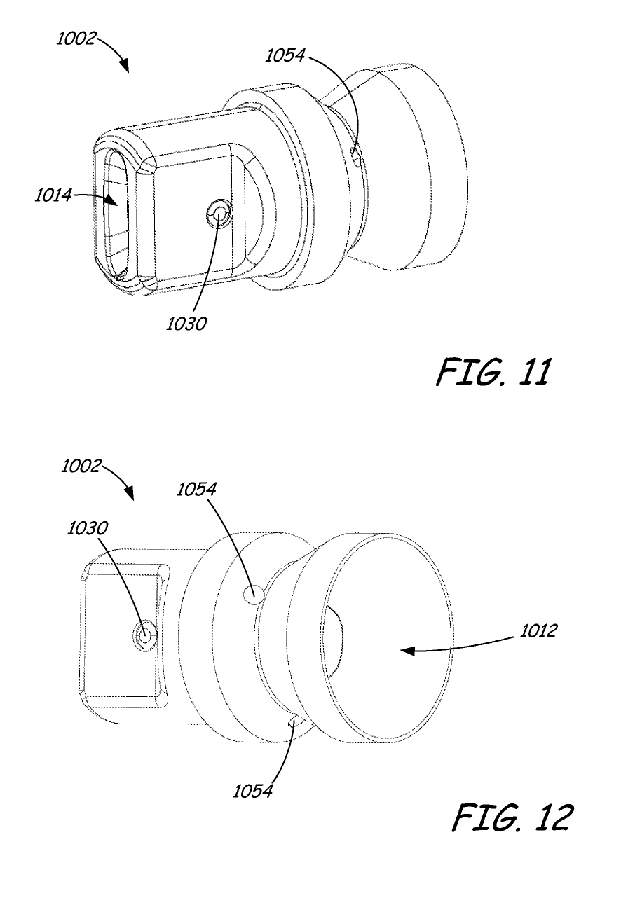

FIGS. 11 and 12 are perspective views of nozzle 1002. FIGS. 11 and 12 illustrate apertures 1012 and 1014, and pin 1030. Further, in the embodiment illustrated in FIGS. 11 and 12, nozzle 1002 includes three apertures 1054 configured to receive the air stream, as illustrated in FIG. 10. In one example, the three apertures 1054 are spaced approximately 120 degrees apart about nozzle 1002.

Referring again to FIG. 2, in the illustrated embodiment the output orifice 203 of air nozzle 205 comprises a single circular opening for delivering air from spray gun 102. However, in other embodiments the output 203 of air nozzle 205 can include different configurations. For instance, output 203 can include openings having different sizes and/or shapes, as well as a plurality of openings. Further, output orifice 203 can include one or more features for shaping the air-flow through air nozzle 205. For example, air nozzle 205 can include a cross-pin positioned in the air stream flowing though air nozzle 205 such that the air stream is disrupted before the air mixes with the fluid provided from chamber 215. Such a cross-pin positioned in the air nozzle 205 can be in place of, or in addition to, a pin (such as pin 230 illustrated in FIG. 3) in the fluid nozzle 202. In one example, a cross-pin positioned in air nozzle 205 is substantially similar to pin 230 illustrated in FIG. 3. The cross-pin can include geometries that are smaller, larger, or the same as pin 230.

Further, in embodiments where both the air nozzle 205 and fluid nozzle 202 include geometric features (e.g., cross-pins, angled surfaces, rounded surfaces, geometric openings, etc.) for shaping the spray pattern, the spray gun 102 and/or nozzle 202 can include a pilot or alignment feature that aligns the fluid nozzle 202 with respect to the air nozzle 205. For example, a pilot or alignment feature can be provided that orients the angle of rotation of the fluid nozzle 202 with respect to the orientation of the air nozzle 205. This is especially advantageous in embodiments where the fluid nozzle 202 can rotate with respect to the end 201 of spray gun 102 and/or the air nozzle 205 is able to rotate within the body of spray gun 102.

It is to be understood that even though numerous characteristics and advantages of various embodiments of the present disclosure have been set forth in the foregoing description, together with details of the structure and function of various embodiments of the disclosure, this disclosure is illustrative only, and changes may be made without departing from the scope of the concepts described herein. For instance, it is noted that the surfaces of nozzles 202 and 1002 can be configured according to any desired material spraying application. This includes modifications to pins 230 and 1002 and/or other surfaces (e.g., surfaces 218, 222, 224, 226, 227) of the nozzle to generate particular material flow and spray pattern characteristics. For example, the shape and/or size of the pin (and/or other surfaces of the nozzle) can be modified to produce a desired spray pattern given the particular materials that are being used. For instance, the nozzle can be configured to spray materials having any of a number of textures, such as course, medium, and/or fine textures.

While various embodiments of the invention have been set forth in the foregoing description, together with details of the structure and function of various embodiments of the disclosure, this disclosure is illustrative only, and changes may be made in detail, especially in matters of structure and arrangement of parts within the principles of the present disclosure to the full extent indicated by the broad general meaning of the terms in which the appended claims are expressed. For example, the particular elements may vary depending on the particular application for the system or method while maintaining substantially the same functionality without departing from the scope and spirit of the present disclosure and/or the appended claims.

What is claimed:

1. A texture spraying system comprising:
a spraying device;
an air source configured to provide pressurized air to the spraying device;
a texture material source configured to provide texture material to the spraying device; and
a spray nozzle mounted proximate an output of the spraying device, wherein the spray nozzle receives a flow of air and a flow of texture material, the spray nozzle including a pin positioned in the air flow and configured to produce a spray pattern that is substantially rectangular.

2. The texture spraying system of claim 1, wherein the spray nozzle includes a cavity extending through the spray nozzle, the cavity having a first input end proximate the spraying device and a second output end, wherein the pin is positioned within a first portion of the cavity formed by a cylindrical sidewall of the spray nozzle.

3. The texture spraying system of claim 2, wherein the cavity includes a second portion formed by a protrusion of the spray nozzle, wherein the protrusion is positioned between the pin and the second output end of the cavity.

4. The texture spraying system of claim 3, wherein the second portion of the cavity formed by the protrusion has a smaller cross-sectional area than the first portion of the cavity formed by the cylindrical sidewall.

5. The texture spraying system of claim 4, wherein the cavity comprises a third portion positioned between the protrusion and the second output end of the cavity, wherein the third portion is formed by a plurality of different angled surfaces of the spray nozzle.

6. The texture spraying system of claim 2 wherein the pin is substantially cylindrical.

7. The texture spraying system of claim 5, wherein the pin is oriented perpendicular to the airflow.

8. The texture spraying system of claim 1, wherein the airflow is provided to the spray nozzle by an air nozzle of the spraying device, wherein the spray nozzle includes an air nozzle seat that is configured to engage the air nozzle.

9. The texture spraying system of claim 1, wherein the nozzle includes a first external surface and a second external surface, wherein the first and second external surfaces are substantially planar and parallel to one another.

10. The texture spraying system of claim 1, wherein the texture material comprises particles having a thickness of at least 0.1 inches.

11. The texture spraying system of claim 1, wherein the air provided by the air source has a pressure of approximately 10-45 pounds per square inch (PSI) inside an air nozzle of the spraying device.

12. A method of spraying texture material, the method comprising:
providing pressurized air to a nozzle of a texture sprayer;
providing texture material to the nozzle of the texture sprayer;
deflecting the pressurized air using a pin positioned in the nozzle such that the pressurized air mixes with the texture material; and
discharging a mixture of the pressurized air and texture material from an output of the nozzle in a spray pattern having a substantially rectangular shape.

13. The method of claim 12, wherein providing texture material to the nozzle comprises actuating a trigger mechanism of the texture sprayer to retract an air nozzle of the texture sprayer from an air nozzle seat, the air nozzle seat being formed by at least one surface of the nozzle.

14. The method of claim 13, wherein providing pressurized air to the nozzle includes actuating the trigger mechanism to a first position and providing texture material to the nozzle comprises actuating the trigger mechanism to a second position that is different than the first position.

15. The method of claim 12, and further comprising:
rotating the nozzle with respect to the texture sprayer to adjust the spray pattern.

16. A nozzle for a texture sprayer, the nozzle comprising:
a first end configured to engage a texture sprayer;
a second end configured to output texture material in a spray pattern that is substantially rectangular, wherein a cavity of the nozzle extends between the first end and the second end; and
a pin positioned in the cavity and configured to deflect a flow of air provided from the texture sprayer such that the airflow mixes with a flow of texture material provided from the texture sprayer.

17. The nozzle of claim 16, wherein the pin is substantially cylindrical and is oriented perpendicular to the flow of air provided from the texture sprayer.

18. The nozzle of claim 16, wherein the pin is positioned in a portion of the cavity formed by a cylindrical sidewall of the nozzle, wherein the cavity is formed by a protrusion of the nozzle that is positioned between the pin and the second end of the nozzle.

19. The nozzle of claim 18, wherein the nozzle is removably coupled to the texture sprayer and is configured to be rotated with respect to the texture sprayer.

20. The nozzle of claim 16, wherein the nozzle comprises an air nozzle seat that is configured to engage an air nozzle of the texture sprayer.
